(19) United States
(12) Patent Application Publication
(10) Pub. No.: US 2024/0122786 A1
(43) Pub. Date: Apr. 18, 2024

(54) MASSAGE DEVICE

(71) Applicant: SHENZHEN SVAKOM TECHNOLOGY CO., LTD., Shenzhen City (CN)

(72) Inventors: YONG YU, Shenzhen City (CN); MINCHAO HE, Shenzhen City (CN); YONGQING WANG, Shenzhen City (CN); GUOHUI ZHANG, Shenzhen City (CN)

(21) Appl. No.: 18/395,711

(22) Filed: Dec. 25, 2023

Related U.S. Application Data
(63) Continuation of application No. 17/833,865, filed on Jun. 6, 2022.

(51) Int. Cl. A61H 9/00; A61H 23/02

(52) U.S. Cl. CPC A61H 9/0057; A61H 23/0263; A61H 2201/0107; A61H 2201/5007; A61H 2201/5046; A61H 2201/5071

(57) ABSTRACT

Provided is a massage device which includes: at least one first housing, having a first sucking port and a receiving space communicated with the at least one first sucking port; at least one movable assembly, movably inserted into the receiving space; and at least one driving assembly, connected with the movable assembly and configured to drive the movable assembly to reciprocate in the receiving space to periodically generate a negative pressure and a positive pressure at the first sucking port. The massage device further includes a massage assembly and a second housing received in the at least one first housing. The at least one movable assembly is received in a first end of the second housing, and the massage assembly is received in an opposite second end of the second housing.

### CROSS REFERENCE TO RELATED APPLICATIONS

This application is a continuation of U.S. application Ser. No. 17/833,865, filed on Jun. 6, 2022, the content of which is incorporated by reference herein.

### BACKGROUND OF THE INVENTION

### Field of the Invention

The present disclosure relates to the field of massaging devices, and in particular to a pressure generator and a massage device.

### Description of Related Art

With the accelerated pace of life, working pressures on people are increased. After daily working, a person may be tired, and various portions of a body may ache. In order to relieve fatigue and soreness, people may take a variety of massage devices to massage the body, such as a negative pressure massage device. The negative pressure massage device may adsorb and relax the skin to relieve the fatigue and soreness, so as to sooth the body and mind. However, the negative pressure massage device in the related art may have a complicated structure, and may have a poor adsorption effect.

Therefore, the massage device in the related art needs to be improved to avoid the above defects.

### BRIEF SUMMARY OF THE INVENTION

The present disclosure provides a massage device which can improve adsorption effect thereof.

The massage device includes: at least one first housing, having a first sucking port and a receiving space communicated with the at least one first sucking port; at least one movable assembly, movably inserted into the receiving space; and at least one driving assembly, connected with the movable assembly and configured to drive the movable assembly to reciprocate in the receiving space to periodically generate a negative pressure and a positive pressure at the first sucking port.

In at least one embodiment, the at least one first housing comprises at least two the first housing spaced apart from each other; and the at least one movable assembly comprises at least two movable assemblies, each movable assembly is movably inserted into respective receiving space, and the driving assembly is connected with the movable assemblies and configured to drive the movable assemblies to reciprocate in the receiving spaces to periodically generate negative pressures and positive pressures at the first sucking ports.

In at least one embodiment, each movable assembly includes a free end, movably inserted into the receiving space; a moving end, connected with the free end; and a connecting rod, connected with an end of the moving end away from the free end. The driving assembly includes: an output shaft; an eccentric shaft, connected with the output shaft and ends of the connecting rods away from the connecting rod. The massage device further includes: a flexible housing, configured to receive the first housing, the movable assembly, and the driving assembly, the flexible housing defines a second sucking port communicated with the first sucking port; and a vibrating motor, received in the flexible housing.

In at least one embodiment, a gap is defined between the movable assembly and an inner wall of the first housing; or the movable assembly is attached with an inner wall of the first housing.

In at least one embodiment, the at least one movable assembly includes two movable assemblies, the at least one driving assembly includes two driving assemblies. The massage device further includes: two second housings, spaced apart from each other, each movable assembly and each driving assembly are received in respective second housing, each second housing defines a third sucking port communicated with the first sucking port; and a flexible connecting member, configured to connect the two second housings together.

In at least one embodiment, the massage device further includes: a circuit board and a touch screen electrically connected with the circuit board, the touch screen is received in and exposed from one of the second housings; or the massage device further includes a circuit board and a pressure sensor electrically connected with the circuit board, the pressure sensor is attached with an inner surface of the flexible housing.

In at least one embodiment, the at least one movable assembly includes two movable assemblies, the at least one driving assembly includes two driving assemblies. The massage device further includes: two flexible housings, spaced apart from each other, the two movable assemblies are respectively received in the flexible housings, the two driving assemblies are also respectively received in the flexible housings; and a flexible connecting member, configured to connect the two flexible housings together.

In at least one embodiment, one of the two first movable assembly includes a connecting rod. One of the two flexible housings includes: a second sucking port; and a sucking film, two ends of the sucking film are connected with two opposite side walls of the second sucking port to form a sucking cavity, the connecting rod is connected with the sucking film. One of the two driving assemblies includes: an output shaft, and an eccentric shaft, connected with the connecting rod and the output shaft.

In at least one embodiment, the massage device further includes: a massage assembly and a second housing, the first housing, the at least one movable assembly is received in a first end of the second housing, the massage assembly is received in a second end of the second housing.

In at least one embodiment, the massage device further includes a flexible member, received in the second housing and arranged between the massage assembly and the movable assembly; or the massage device further includes a battery, a circuit board, and a conducting plate electrically connected with the battery and the circuit board, the battery and the circuit board are received in the second housing, the conducting plate is received in the second housing and exposed from the second housing.

In at least one embodiment, the at least one driving assembly includes a first driving assembly and a second driving assembly. The movable assembly includes: a free end, movably inserted into the receiving space; a moving end, connected with the free end; and a connecting rod, connected with an end of the moving end away from the free end. The first driving assembly includes an output shaft, and an eccentric shaft connected with the connecting rods and the output shaft.

In at least one embodiment, the massage assembly includes: two claws; a pin, connected with the two claws and configured to allow the two claws to move towards each other or move away from each other. The second driving assembly includes: an output shaft; an elliptical limiting member, having an elliptical groove and connected with the output shaft, ends of the two claws are received in the elliptical groove and limited by a side wall of the elliptical groove.

In at least one embodiment, the massage device includes a flexible housing, sleeved on the second housing and having a patting pat. The second housing defines a first through hole. The massage assembly includes: a connecting rod, configured to pass through the first through hole and connect with the patting part. The second driving assembly includes: an output shaft, and an eccentric shaft, connected with the output shaft and an end of the connecting rod away from the patting part.

In at least one embodiment, the massage device includes a flexible housing, sleeved on the second housing and having a patting pat. The second housing defines: a concaving part, concaved away from the flexible housing, the concaving part and the flexible housing cooperatively forms a sealed cavity, the concaving part defines a second through hole. The massage assembly includes: a connecting rod, configured to pass through the second through hole and connect with the patting part. The second driving assembly includes: an output shaft; and an eccentric shaft, connected with the output shaft and an end of the connecting rod away from the patting part.

In at least one embodiment, the massage device includes: a flexible housing, connected with the second housing, and a vibrating motor, received in the flexible housing.

In at least one embodiment, the massage assembly includes a wriggling member, received in the second housing, the wriggling member includes a plurality of wriggling plates, stacked in sequence, each wriggling plates defines a third through hole; and a driving rod, configured to connect with the second driving assembly and pass through the third through holes, the wriggling plates are rotatably sleeved on the driving rod.

In at least one embodiment, the massage assembly includes a vibrating motor, received in the second housing and connected with an end of the driving rod exposed from the third through holes.

In at least one embodiment, the wriggling plate has a round shape or an elliptic shape; or the wriggling plate comprises an eccentric block protruded from a top surface of the wriggling plate and eccentrically surrounded around a periphery of a side wall of the third through hole, a groove arranged on a bottom surface of the wriggling plate, at least two third protruding members protruded from a bottom surface of the groove, each eccentric block defines a fourth through hole communicated with the third through hole, and the eccentric block is rotatably received in the groove and limited by the at least two third protruding members; or the wriggling plate comprises at least two first protruding members protruded from a top surface of the wriggling plate, at least two second protruding members protruded from a bottom surface of the wriggling plate, and a massage protrusion protruded from a side surface of the wriggling plate, the first protruding member is engaged with the respective second protruding member.

In at least one embodiment, the massage device includes: a flexible housing, sleeved around the second housing. The massage assembly includes: a vibrating motor, received in the second housing and flexible housing; and a temperature regulating member, arranged between the flexible housing and the second housing, the temperature regulating member includes a heating coil, or a semiconductor chilling plate.

In at least one embodiment, the massage device includes: a flexible housing, sleeved around the second housing and having a retractable part. The massage assembly includes: a driving shaft, connected with an output shaft of the second driving assembly; a fixing sleeve, sleeved on the driving shaft; a retractable sleeve, sleeved on the fixing sleeve and connected with the retractable part; and a connecting member, passed through the retractable sleeve, the fixing sleeve and guided by the driving shaft.

In the technical solution of the present disclosure, the at least one driving assembly is configured to drive the movable assembly to reciprocate in the receiving space to periodically generate a negative pressure and a positive pressure at the first sucking port, to massage and stimulate the sensitive portions. In this way, the massage device may provide a better adsorption effect.

### BRIEF DESCRIPTION OF THE DRAWINGS

FIG. 1 is a structural schematic view of a massage device according to a first embodiment of the present disclosure.

FIG. 2 is a cross-sectional view of the massage device as shown in FIG. 1.

FIG. 3 is an exploded view of the massage device as shown in FIG. 1.

FIG. 4 is a structural schematic view of a massage device according to a second embodiment of the present disclosure.

FIG. 5 is an exploded view of the massage device as shown in FIG. 4.

FIG. 6 is a cross-sectional view of the massage device as shown in FIG. 4.

FIG. 7 is a cross-sectional view of a massage device according to a third embodiment of the present disclosure.

FIG. 8 is a cross-sectional view of a massage device according to a fourth embodiment of the present disclosure.

FIG. 9 is a structural schematic view of an elliptical limiting member of the massage device as shown in FIG. 8.

FIG. 10 is a cross-sectional view of a massage device according to a fifth embodiment of the present disclosure.

FIG. 11 is a cross-sectional view of a massage device according to a sixth embodiment of the present disclosure.

FIG. 12 is a cross-sectional view of a massage device according to a seventh embodiment of the present disclosure.

FIG. 13 is a structural schematic view of a massage device according to an eighth embodiment of the present disclosure.

FIG. 14 is an exploded view of the massage device as shown in FIG. 13.

FIG. 15 is a cross-sectional view of the massage device as shown in FIG. 13.

FIG. 16 is a cross-sectional view of a massage device according to a ninth embodiment of the present disclosure.

FIG. 17 is a structural schematic view of a driving assembly and a massage assembly of the massage device as shown in FIG. 16.

FIG. 18 is a structural schematic view of a wriggling plate of the massage device as shown in FIG. 16.

FIG. 19 is similar to FIG. 18, but shown from another view.

FIG. 20 is a structural schematic view of a mounting element of the massage device as shown in FIG. 16.

FIG. 21 is a cross-sectional view of a massage device according to a tenth embodiment of the present disclosure.

FIG. 22 is a structural schematic view of a driving assembly and a massage assembly of the massage device as shown in FIG. 21.

FIG. 23 is a structural schematic view of a wriggling plate of the massage device as shown in FIG. 21.

FIG. 24 is similar to FIG. 23, but shown from another view.

FIG. 25 is a cross-sectional view of a massage device according to an eleventh embodiment of the present disclosure.

FIG. 26 is an enlarged view of a portion A as shown in FIG. 25.

FIG. 27 is a cross-sectional view of a massage device according to a twelfth embodiment of the present disclosure.

FIG. 28 is a structural schematic view of a fixing sleeve of the massage device as shown in FIG. 27.

FIG. 29 is a structural schematic view of a driving shaft of the massage device as shown in FIG. 27.

FIG. 30 is similar to FIG. 29, but shown from another view.

FIG. 31 is a structural schematic view of another driving shaft of the massage device.

FIG. 32 is a structural view of the massage assembly and a driving assembly as shown in FIG. 27.

FIG. 33 is an exploded view of the massage assembly and a driving assembly as shown in FIG. 32.

### DETAILED DESCRIPTION OF THE INVENTION

Technical solutions in the embodiments of the present disclosure will be clearly and completely described below by referring to the accompanying drawings in the embodiments of the present disclosure. Obviously, the described embodiments are only a part of, but not all of, the embodiments of the present disclosure. All other embodiments obtained by a person of ordinary skill in the art based on the embodiments in the present disclosure and without making creative work shall fall within the scope of the present disclosure.

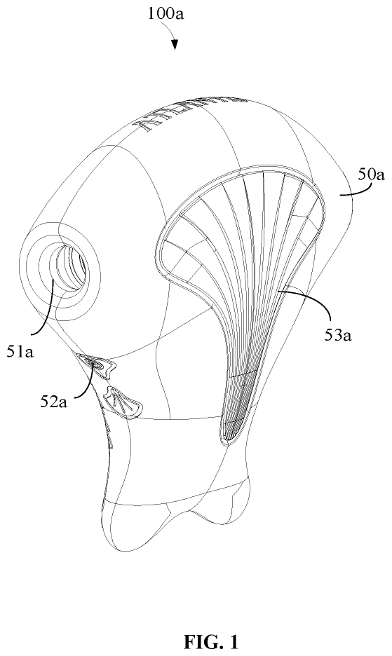

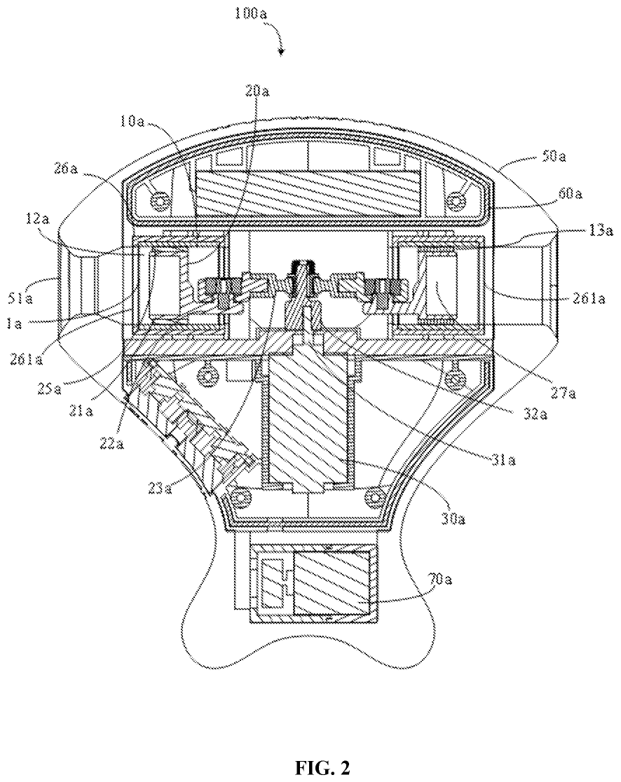

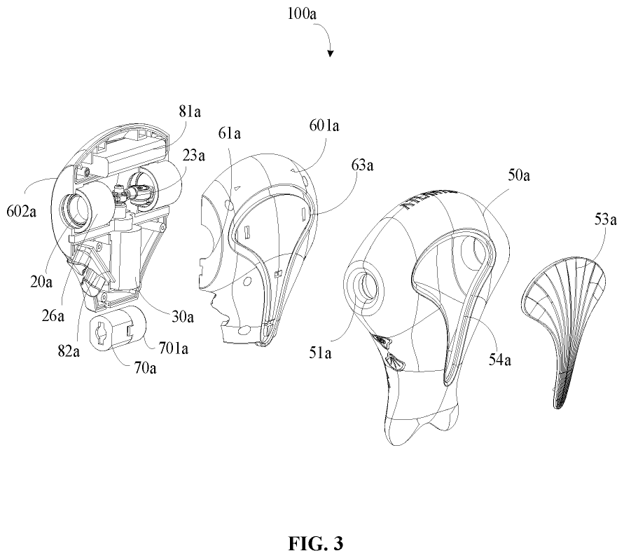

As shown in FIGS. 1 to 3, the present disclosure provides a massage device 100a according to a first embodiment. The massage device 100a is configured to massage a body of a user, especially to massage sensitive portions of the body. The massage device 100a may generate a negative pressure and a positive pressure to massage and stimulate the sensitive portions. The massage device 100a includes at least one first housing 10a, at least one movable assembly 20a, and at least one driving assembly 30a. The first housing 10a has at least one first sucking port 11a and at least one receiving space 12a communicated with the at least one first sucking port 11a. The at least one movable assembly 20a is movably inserted into the receiving space 12a. The at least one driving assembly 30a is connected with the movable assembly 20a and configured to drive the movable assembly 20a to reciprocate in the receiving space 12a to periodically generate the negative pressure and the positive pressure at the first sucking port 11a. The movable assembly 20a is configured to separate the receiving space 12a into a first chamber (not labeled) and a second chamber (not labeled). The first chamber is communicated with the first sucking port 11a. When in use, the first sucking port 11a is attached to human body, and the driving assembly 30a drives the movable assembly 20a to move away from the first sucking port 11a so that a volume of the first chamber is increased and the negative pressure is generated at the first sucking port 11a. Therefore, the first sucking port 11a can be sucked onto the human body under the negative pressure. Further, the driving assembly 30a drives the movable assembly 20a to move towards from the first sucking port 11a so that the volume of the first chamber is decreased and the positive pressure is generated at the first sucking port 11a, to provide a better massage effect.

In at least one embodiment, there are at least two first housing 10a spaced apart from each other, at least two first sucking ports 11a spaced apart from each other, and at least two receiving spaces 12a spaced apart from each other, each first sucking port 11a is communicated with the respective receiving space 12a. The massage device 100 includes at least two movable assemblies 20a, each movable assembly 20a is movably inserted into respective receiving space 12a, and the driving assembly 30a is connected with the movable assemblies 20a and configured to drive the movable assemblies 20 to reciprocate in the receiving spaces 12a to periodically generate negative pressures and positive pressures at the first sucking ports 11a.

In at least one embodiment, the first housing 10a is rigid, and the first housing 10a is made of thermosetting plastic.

In at least one embodiment, each movable assembly 20a includes a free end 21a movably inserted into the receiving space 12a, a moving end 21a connected with the free end 21a, and a connecting rod 23a connected with an end of the moving end 21a away from the free end 21a. The driving assembly 30 includes an output shaft 31a, and an eccentric shaft 32a connected with the output shaft 31a and ends of the connecting rods 23a away from the connecting rod 23a. The two connecting rods 23a may rotate simultaneously under an action of the driving assembly 30.

In at least one embodiment, the movable assembly 20a is attached with an inner wall of the first housing 10a. So that there is no gap between the movable assembly 20a and the inner wall of the first housing 10a.

In at least one embodiment, an outer surface of the free end 21a is attached with the inner wall of the first housing 10a.

In at least one embodiment, a gap 13a is defined between the movable assembly 20a and the inner wall of the first housing 10a.

In at least one embodiment, the gap 13a is defined between the outer surface of the free end 21a and the inner wall of the first housing 10a.

In at least one embodiment, each movable assembly 20a includes a sealing ring 25a and a protecting housing 26a, the first housing 10a is received in the protecting housing 26a, and the sealing ring 25a is arranged between the first housing 10a and the protecting housing 26a. The first housing 10a defines a receiving groove (not labeled) for receiving the sealing ring 25a. The sealing ring 25a is preferably 0-shaped.

In at least one embodiment, the sealing ring 25a is made of soft and flexible material, such as rubber or silicone, as such the soft and flexible sealing ring 25a can tightly connect with the inner wall of the first housing 10a and the outer wall of the free end 21a.

In at least one embodiment, the sealing ring 25a is made of metal, preferably made of aluminum alloy or the like.

In the present embodiment, the sealing ring 25a and the side wall of the free end 21a are configured as a one-piece structure. The one-piece structure is plastic, and formed by an injection molding.

In the present embodiment, the gap 13a is defined between the sealing ring 25a and the inner wall of the first housing 10a. Only when the gap 13a is not greater than 0.1 mm, preferably not greater than 0.05 mm, a dynamic pressure may be generated at the first sucking port 11a. By defining the gap 13a to be smaller, a larger noise may be prevented while using the massage device 100a, thereby reducing the noise.

In at least one embodiment, the protecting housing 26a is made of a cushioning material, such as silicone, rubber, or the like.

In at least one embodiment, the protecting housing 26a defines a through hole 261a communicated with the first sucking port 11a.

In at least one embodiment, a cavity 27a is defined in the free end 21a. The cavity 27a is communicated to the receiving space 12a. The cavity 27a allows a volume of the receiving space 12a to be increased so that a large pressure variation range and a large pressure variation space are achieved. At the same time, the cavity 27a may increase a contact area between the movable assembly 20a and air in the receiving space 12a, such that the movable assembly 20a may be subjected to a uniform force while moving, and the movable assembly 20a may move stably.

The massage device 100a further includes a flexible housing 50a which includes a top flexible housing (not labeled) and a bottom flexible housing (not labeled) detachably connected with the top flexible housing. The flexible housing 50a defines at least one second sucking port 51a communicated with the first sucking port 11a. The first housing 10a, the movable assembly 20a, and the driving assembly 30a are received the flexible housing 50a. A periphery of a wall of the second sucking port 51a is configured to contact the skin of the human body. Periodic alternating positive and negative pressures may be conducted to the skin through the second sucking port 51a to stimulate the skin and achieve a massaging effect.

In at least one embodiment, the flexible housing 50a may be made of a cushioning material, such as silicone, rubber, or the like.

In at least one embodiment, the top flexible housing has a semicircular port (not labeled), and the bottom flexible housing also has a semicircular port (not labeled). After the top flexible housing is connected with the bottom flexible housing, the two semicircular ports cooperatively form the second sucking port 51a.

In at least one embodiment, the flexible housing 50a defines a first decorating hole 54a, the massage device 100a further includes a decorating member 53a received in the decorating hole 54a.

The massage device 100a further includes a second housing 60a which includes a top housing 601a and a bottom housing 602a detachably connected with the top housing 601a. The second housing 60a is received in the flexible housing 50a.

In at least one embodiment, the second housing 60a is rigid, and the second housing 60a is made of thermosetting plastic.

In at least one embodiment, the second housing 60a defines a second decorating groove 63a, the decorating member 53a is received in the first decorating hole 54a and the second decorating groove 63a.

In at least one embodiment, the second housing 60a defines a third sucking port 61a communicated with the first sucking port 11a and the second sucking port 51a.

In at least one embodiment, the massage device 100a further includes a switch 52a exposed from the second housing 60a and the flexible housing 50a. The switch 52a is electrically connected with a circuit board 82b received in the second housing 50a. User may press or touch the switch 52a to turn on or turn off the massage device 100a.

In at least one embodiment, the massage device 100a further includes a battery (not labeled) which is electrically connected with the at least one driving assembly 30a and the circuit board 82b. The battery is configured to provide power to the driving assembly 30a.

In at least one embodiment, the massage device 100a further includes a vibrating motor 70a received in the flexible housing 50a. In detail, the vibrating motor 70a is arranged at a portion of the flexible housing 50a adjacent to the second housing 60a.

In at least one embodiment, the massage device 100a further includes a mounting member 701a received in the flexible housing 50a, the mounting member 701a is configured to mount the vibrating member 70a.

In at least one embodiment, the flexible housing 50a and the second housing 60a both has a conchoidal shape.

In at least one embodiment, the protecting housing 26a is disposed between the first housing 10a and the second housing 60a. By arranging the protecting housing 26a, transmission of vibration to the outside may be reduced, and on the other hand, transmission of noise, which is generated due to the movable member 20a moving while the movable member 20a contacts the first housing 10a, to the outside may be reduced, such that noise may be reduced.

It should be understood that, the driving assembly 30a is not limited to the driving assembly 30a shown in the first embodiment. For example, the driving assembly 30a can be an electromagnetic driver. The electromagnetic driver includes a first magnetic component and a second magnetic component connected to the transmission member. One of the first magnetic component and the second magnetic component is a coil, and the other one of the first magnetic component and the second magnetic component is a magnet. When the coil is energized, interaction force between the first magnetic component and the second magnetic component can drive the movable assembly 20a to reciprocated move. The magnet can be a permanent magnet or an electromagnet.

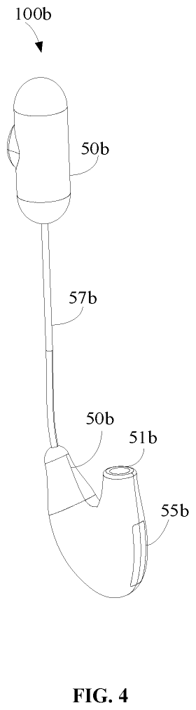

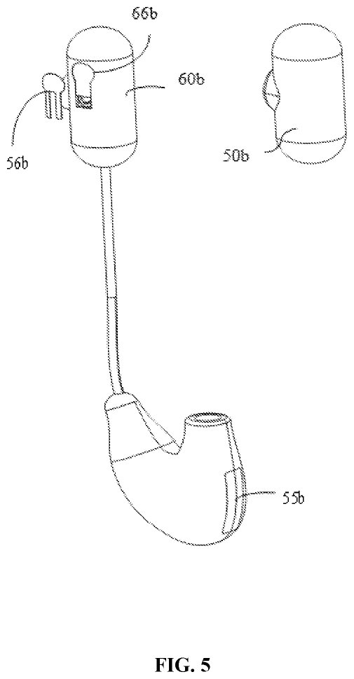

As shown in FIGS. 4 to 6, the present disclosure provides a massage device 100b according to a second embodiment. The massage device 100b is similar with the massage device 100a in structure. The differences between the massage device 100b and the massage device 100a include: (a). the massage device 100b includes two flexible housing 50b spaced apart from each other, and a flexible connecting member 57b configured to connect the two second housing 60b and the two flexible housing 50b together, each flexible housing 50b is sleeved on respective second housing 60b; (b). the massage device 100b further includes two movable assemblies 20b and two driving assemblies 30b, each movable assembly 20b and each driving assembly 30b are received in respective second housing 60b and respective second housing 60b; (c). the massage device 100b further includes a touch screen 55b electrically connected with the circuit board 82b, the touch screen 55b is received in and exposed from one of the flexible housings 50a; (d). the massage device 100b further includes a pressure sensor 56b electrically connected with the circuit board 82b, the pressure sensor 56b is attached with an inner surface of the flexible housing 50b.

In at least one embodiment, the second housing 60b defines a receiving hole 66b, the pressure sensor 56b is received in the receiving hole 66b and attached with the inner surface of the flexible housing 50.

In at least one embodiment, the flexible connecting member 57b has a first via hole 571b, a wire may pass through the first via hole 571b to electrically connect the circuit board 82b and the battery 81b with the driving assemblies 30b.

In at least one embodiment, the flexible connecting member 57b is made of a material capable of being bent and shaped, such as a memory alloy or the like.

In at least one embodiment, each second housing 60b has a second via hole (not labeled), and each second housing 60b also has a third via hole (not labeled), both ends of the flexible connecting member 57b are provided with a limiting element 572b, a size of the limiting element 572b is larger than that of the second via hole and third via hole. The limiting elements 572b are limited by peripheries of sidewalls of the flexible housings 50b and the second housings 60b, for preventing the flexible connecting member 57 escaping from the flexible housings 50b and the second housings 60b.

It should be understood that, the flexible housing 50b with the pressure sensor 56b may be placed in sensitive portions to massage.

It should be understood that, a structure of the movable assembly 20b is the same as that of the movable assembly 20a, and a structure of the driving assembly 30b is the same as that of the driving assembly 30a.

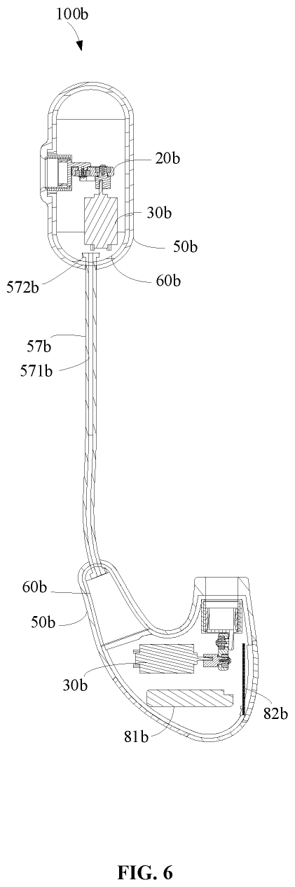

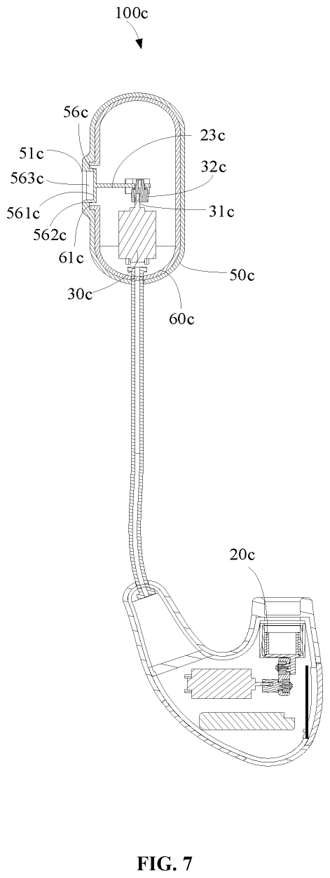

As shown in FIG. 7, the present disclosure provides a massage device 100c according to a third embodiment. The massage device 100c is similar with the massage device 100b in structure. The differences between the massage device 100c and the massage device 100b include: (a). the massage device 100c includes two movable assemblies 20c defining as a first movable assembly and a second movable assembly, a structure of the first movable assembly is the same as that of the movable assembly 20b, and a structure of the a second movable assembly is the different from that of the movable assembly 20b.

In at least one embodiment, the second movable assembly includes a connecting rod 23c. One flexible housing 50c includes a second sucking port 51c and a sucking film 56c, two ends of the sucking film 56c are connected with two opposite side walls of the second sucking port 51c to form a sucking cavity 563c, the connecting rod 23c is connected with the sucking film 56c. The connecting rod 23c is connected with the output shaft 31c and the eccentric shaft 32c of the driving assembly 30c.

It should be understood that, the connecting rod 23c and the sucking film 56c can be regarded as a massage assembly 90c.

In at least one embodiment, the sucking film 56c includes a sucking portion 561c connected with the connecting rod 23c, and two connecting portions 562c connected with the connecting portion 561c and the side wall of the second sucking port 51c.

In at least one embodiment, the sucking film 56c passes through the third sucking port 61c of the second housing 60c.

It should be understood that, the flexible housing 50c with the connecting rod 23c may be placed in sensitive portions to massage.

When the driving assembly 30c works, the output shaft 31c and the eccentric shaft 32c bring the connecting rod 23c to move back and forth. In this way, the connecting rod 23c bring the sucking film 56c to move back and forth, and a size of the sucking cavity 563c becomes bigger or smaller, so as to periodically generate the negative pressure and the positive pressure at the second sucking port 51c.

In at least one embodiment, the sucking film 56c may be made of flexible materials, such as silicone, thermoplastic plastics, or the like.

It should be understood that, the flexible housing 50c with the connecting rod 23c may be placed in sensitive portions to massage.

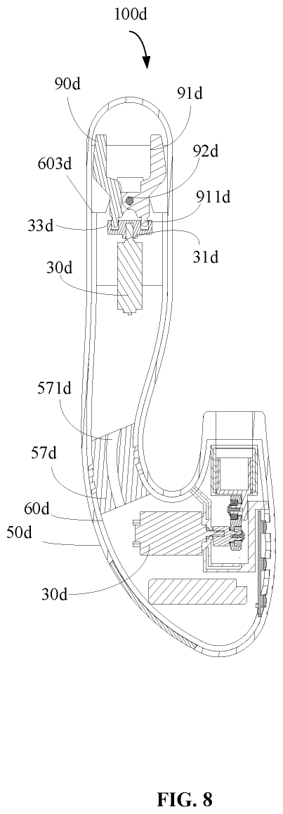

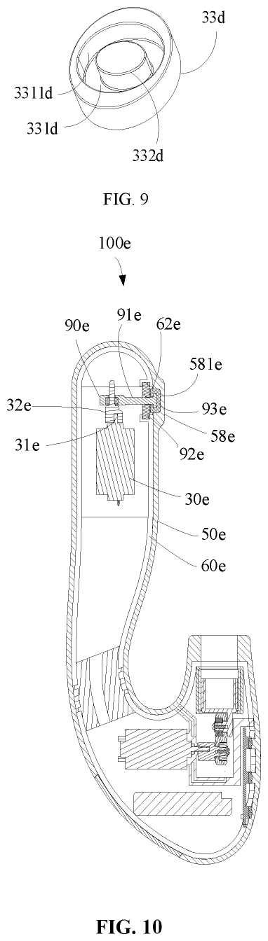

As shown in FIGS. 8 and 9, the present disclosure provides a massage device 100d according to a fourth embodiment. The massage device 100d is similar with the massage device 100a in structure. The differences between the massage device 100d and the massage device 100a include: (a). the massage device 100d includes a massage assembly 90d; (b). the massage device 100d includes two driving assemblies 30d defining a first driving assembly and a second driving assembly, the first driving assembly is similar to the driving assembly 20a in structure, the second driving assembly is different from the driving assembly 30a in structure; (b). the massage device 100d further includes a flexible member 57d, received in the second housing 60d and arranged between the first movable assembly and the second movable assembly.

In at least one embodiment, the flexible member 57d is made of a material capable of being bent and shaped, such as a memory alloy or the like. The flexible connecting member 57b has a via hole 571b, a wire may pass through the first via hole 571b to electrically connect the circuit board and the battery with the driving assemblies 30b.

In at least one embodiment, the two driving assemblies 30d are also received in two opposite ends of the second housing 60d.

In at least one embodiment, the massage assembly 90d includes two claws 91d, a pin 92d connected with the two claws 91d and configured to allow the two claws 91d to move towards each other or move away from each other. The second driving assembly includes an output shaft 31d and a driving member 33d. The driving member 33d has an elliptical groove 331d and connected with the output shaft 31d, ends 911d of the two claws 91d are received in the elliptical groove 331d and limited by a side wall 3311d of the elliptical groove 331d.

In at least one embodiment, the driving member 33d has an elliptical shape. A surface of the driving member 33d has the elliptical groove 331d, a protrusion 332d is received in the elliptical groove 331d. Ends of the two claws 91d are received in the elliptical grooves 331d and limited by the side wall 3311d of the elliptical groove 331d and the protrusion 332d.

In at least one embodiment, the protrusion 332d has an elliptical shape.

In at least one embodiment, an end of the second housing 60d has a notch 603d, the claws 91d pass through the notch 603d and received in flexible housing 50d.

It should be understood that, the flexible housing 50d with the claws 91d may be placed in sensitive portions to massage.

When the driving assembly 30d works, the output shaft 31d and the driving member 33d bring the claws 91d to move towards each other or move away from each other, to push the flexible housing 50d to move outwards or move back, so as to massage the sensitive positions. During moving, the claws 91d are limited by the side wall 3311d of the elliptical groove 331d.

As shown in FIG. 10, the present disclosure provides a massage device 100e according to a fifth embodiment. The massage device 100e is similar with the massage device 100d in structure. The differences between the massage device 100e and the massage device 100d include: the massage device 100e includes a massage assembly 90e which includes a connecting rod 91e, configured to pass through the second housing 60e and connect with the flexible housing 50e.

In at least one embodiment, the second housing 60e defines a first through hole 62e, the flexible housing 50e has the patting part 58e, the connecting rod 91e passes through the first through hole 62e and connects with the patting part 58e.

In at least one embodiment, the second movable assembly further includes a positioning member 92e, and a buffering member 93e. The connecting rod 91e passes through the positioning member 92e and the first through hole 62e in sequence, connects with the buffering member 93e.

In at least one embodiment, the flexible housing 50e defines a groove 581e, the buffering member 93e is at least partially received in the groove 581e.

In at least one embodiment, the connecting rod 91e is partially received in the buffering member 93e.

It should be understood that, the flexible housing 50e with the patting part 58e may be placed in sensitive portions to massage.

When the driving assembly 30e works, the output shaft 31e and the eccentric shaft 32e bring the connecting rod 91e to move forward or backward, to push the patting part 58e to move outwards or move back, so as to massage the sensitive positions. During moving, the connecting rod 91e is supported and positioned by the positioning member 92e, and the negative pressure and the positive pressure may be applied to the sensitive positions.

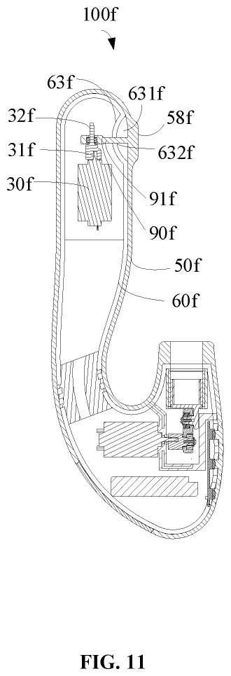

As shown in FIG. 11, the present disclosure provides a massage device 100f according to a sixth embodiment. The massage device 100f is similar with the massage device 100e in structure. The differences between the massage device 100f and the massage device 100e include: the massage device 100f includes a massage 90f which includes a connecting rod 91f, the connecting rod 91f is configured to pass through the second housing 60f and connect with the patting pat 58f of the flexible housing 50f, the flexible housing 50f is sleeved on the second housing 60f and has a patting pat 58f, the second housing 60f defines a concaving part 63f, concaved away from the flexible housing 50f, the concaving part 63f and the flexible housing 50f cooperatively forms a sealed cavity 631f, the concaving part 63f defines a second through hole 632f.

In at least one embodiment, the connecting rod 91f passes through the second through hole 632f of the second housing 60f and connects with the patting pat 58f.

It should be understood that, the flexible housing 50f with the patting part 58f may be placed in sensitive portions to massage.

It should be understood that, the connecting rod 91f, the patting pat 58f and the concaving part 63f can be regarded as a massage assembly 90f.

When the driving assembly 30f works, the output shaft 31f and the eccentric shaft 32f bring the connecting rod 91f to move forward or backward, to push the patting part 58f to move outwards or move back, so as to massage the sensitive positions. During the movement of the connecting rod 91f, the sealed cavity 631f becomes larger or smaller, and the negative pressure and the positive pressure may be applied to the sensitive positions.

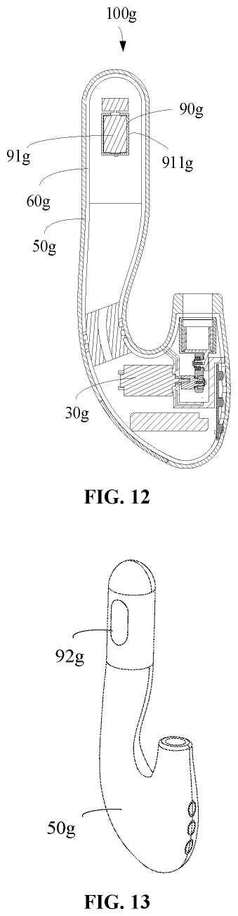

As shown in FIGS. 12 to 13, the present disclosure provides a massage device 100g according to a seventh embodiment. The massage device 100g is similar with the massage device 100e in structure. The differences between the massage device 100g and the massage device 100e include: (a). the massage device 100g includes a massage assembly 90g which includes a vibrating motor 91g received in the flexible housing 50g, and a mounting wall 911g configured to mount the vibrating motor 91g.

In at least one embodiment, the massage assembly 90g further includes a conducting plate 92g electrically connected with the battery (not labeled) and the circuit board (not labeled).

In at least one embodiment, the conducting plate 92g is received in the second housing 60g and exposed from the second housing 60g.

In at least one embodiment, the conducting plate 92g is received in the flexible housing 50g and exposed from the flexible housing 50g.

It should be understood that, the flexible housing 50g with the vibrating motor 91g may be placed in sensitive portions to massage.

When the driving assembly 30g works, the vibrating motor 91g vibrates to massage the sensitive positions, and the conducting plate 92g may generate a microcurrent to stimulate the sensitive positions.

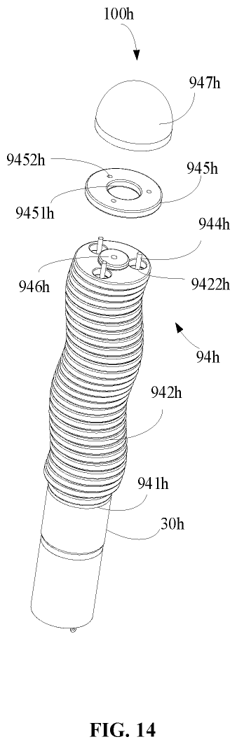

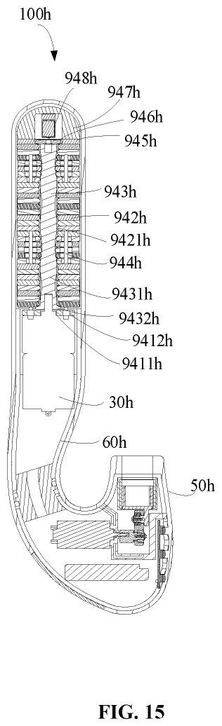

As shown in FIGS. 14 and 15, the present disclosure provides a massage device 100h according to an eighth embodiment. The massage device 100h is similar with the massage device 100e in structure. The differences between the massage device 100h and the massage device 100e include: the massage assembly 90h includes a wriggling member 94h, received in the second housing 60h and the flexible housing 50h.

In at least one embodiment, the wriggling member 94h includes a mounting element 941h, a plurality of wriggling plates 942h stacked in sequence, a driving rod 943h, at least one limiting rod 944h, a baffle plate 945h, a limiting element 946h, and a protecting cover 947h. The driving rod 943h has an S shape, or has a helical shape. The wriggling plates 942h are rotatably sleeved on the driving rod 943h.

In at least one embodiment, the wriggling plate 942h has a round shape or an elliptic shape.

In at least one embodiment, the mounting element 941h defines a third through hole 9411h, and a plurality of fourth through holes 9412h. The third through hole 9411h is defined at a center portion of the mounting element 941h, the fourth through holes 9412h are arranged around the third through hole 9411h.

In at least one embodiment, the fourth through holes 9412h are evenly distributed on the mounting member 942h with the third through hole 9411h as the center.

In at least one embodiment, the driving assembly 30h is mounted on the mounting element 941h. An output shaft 31h of the driving assembly 30h passes through the third through hole 9411h, and connects with the driving rod 943h. In this way, the driving rod 943h may rotate under an action of the driving assembly 30h.

In at least one embodiment, the wriggling plates 942h are matched with the driving rod 943h in a clearance fit mode.

In at least one embodiment, the driving rod 943h includes a main body 9431h and a limiting portion 9432h connected with an end of the main body 9431h adjacent to the mounting element 941h. The main body 9431h has an S shape, or has a helical shape. A diameter of the limiting portion 9432h is larger than that of the main body 9431h. The limiting portion 9432h has a through hole (not labeled) through which the output shaft 31h passes through.

In at least one embodiment, the limiting rod 944h is configured to limit a rotation amplitude of the wriggling plates 942h. There are three limiting rods 944h, the limiting rods 944h are evenly distributed with the driving rod 943h as the center. One end of the limiting rod 944h is connected with the mounting element 941h. In detail, one end of the limiting rod 944h is received in the fourth through hole 9412h.

In at least one embodiment, the wriggling plate 942h defines a fifth through hole 9421h through which the driving rod 943h passes through, and a sixth through hole 9422h through which the limiting rod 944h passes through. The wriggling plate 942h may rotate relative to the driving rod 943h. An area of the sixth through hole is larger than that of the limiting rod 944h. A number of the sixth through hole is equal to a number of the limiting rod 944h. The limiting rods 944h and the sixth through holes are all arranged with the driving rod 943h as the center, so as to improve the stability of the wriggling plates 942h. A diameter of the limiting portion 9432h is larger than a diameter of the fifth through hole 9421h, as such the limiting portion 9432h may separate the mounting element 941h from the wriggling plates 942h.

In at least one embodiment, the baffle plate 945h is connected with the limiting rod 944h, and configured to limit axial positions of wriggling plates 942h and prevent the wriggling plates 942h from escaping from the driving rod 943h and limiting rods 944h. The baffle plate 945h defines a receiving hole 9451h for receiving the limiting element 946h, and at least one seventh through hole 9452h through which the limiting rod 944h passes. The baffle plate 945h has a round shape, and the receiving hole 9451h is defined at a center of the baffle plate 945h.

In at least one embodiment, the limiting element 946h is connected with an end of the driving rod 943h away from the driving assembly 30h. The limiting element 946h has a round shape, the limiting element 946h is rotatably received in the receiving hole 9451h. A diameter of the limiting element 946h is larger than an aperture of the fifth through hole 9421h, for preventing the wriggling plates 942h from escaping from the driving rod 943h. That is, the limiting element 946h is configured to limit the axial positions of the wriggling plates 942h.

In at least one embodiment, the protecting cover 947h is connected with a side of the baffle plate 945h away from the wriggling plates 942h. The protecting cover 947h defines at least one connecting hole (not labeled), the limiting rod 944h passes through the baffle plate 945h, and received in the connecting hole.

In at least one embodiment, the protecting cover 947h defines an avoiding hole (not labeled) at a center of the protecting cover 947h, three connecting holes are evenly arranged with the avoiding hole as the center. A diameter of the avoiding hole is larger than that of the limiting element 946h, for prevent an interference to the rotation of the limiting element 946h.

In at least one embodiment, the protecting cover 947h is made of flexible material, such as silicone, rubber, or the like.

In at least one embodiment, the massage assembly 90h includes a vibrating motor 948h, received in the protecting cover 947h, and connected with an end of the driving rod 943h exposed from the fifth through hole 9421h.

It should be understood that, the end of the flexible housing 50h with the massage assembly 90h may be placed in sensitive portions to massage.

When the driving assembly 30h works, the driving rod 943h rotates, and beings the wriggling plates 942h to move radially in a circular manner.

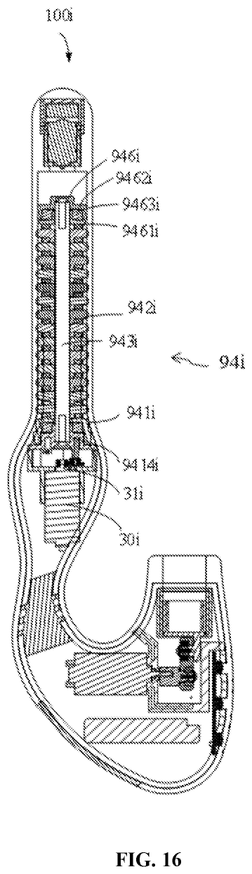

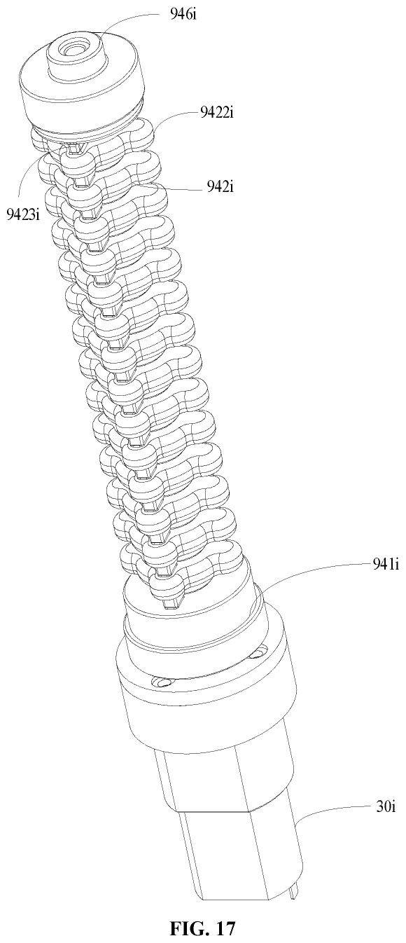

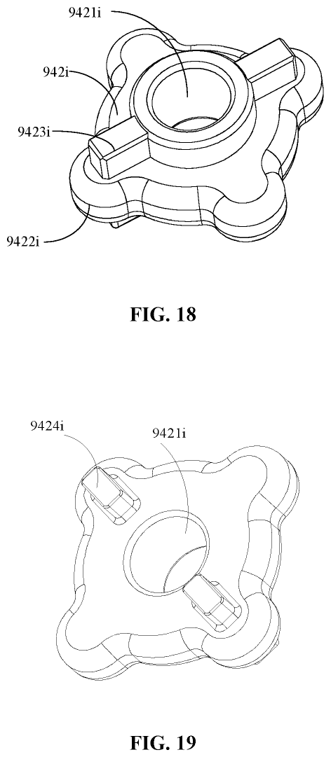

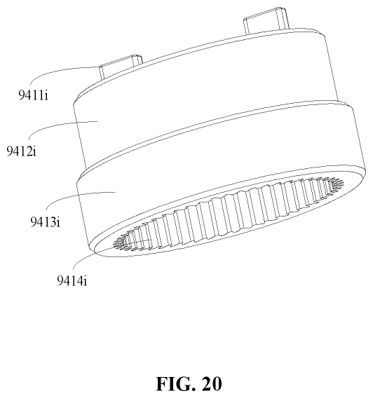

As shown in FIGS. 16 to 20, the present disclosure provides a massage device 100i according to a ninth embodiment. The massage device 100i is similar with the massage device 100h in structure. The differences between the massage device 100i and the massage device 100h include: the mounting element 941i, the wriggling plate 942i, and the limiting element 946i are different from the mounting element 941h, the wriggling plate 942h, and the limiting element 946h.

In at least one embodiment, an outer periphery of the wriggling plate 942i defines at least one massage protrusion 9422i.

In at least one embodiment, the mounting element 941i and the limiting element 946i are respectively arranged on two ends of the driving rod 943i. The mounting element 941i is configured to bring the wriggling plates 942i to rotate around the driving rod 943i. In detail, the wriggling plates 942i rotate around the driving rod 943i in sequence, and the massage protrusion 9422i rolls in waves to massage. The wriggling plates 942i are matched with the driving rod 943i in a clearance fit mode, and the motivation is transmitted to the wriggling plates 942i in sequence. Even if some of the wriggling plates 942i cannot rotate due to being stuck, other wriggling plates 942i can still rotate normally.

In at least one embodiment, a top surface of the wriggling plate 942i has at least two first engaging protrusions 9423i arranged around the driving rod 943i, a bottom surface of the wriggling plate 942i has at least two second engaging protrusions 9424i arranged around the driving rod 943i, a top surface of the mounting element 941i has at least one third engaging protrusion 9411i spaced apart from the driving rod 943i, preferably, the mounting element 941i has at least two third engaging protrusions 9411i. A bottom surface of the limiting element 946i has at least two fourth engaging protrusions 9461i arranged around the driving rod 943i. The first engaging protrusions 9423i are arranged at equal angular intervals, the second engaging protrusions 9424i are arranged at equal angular intervals, the third engaging protrusions 9411i are arranged at equal angular intervals, and the fourth engaging protrusions 9461i are arranged at equal angular intervals. When the driving rod 943i rotates. All the protrusions move circumferentially around the driving rod 943i, the first engaging protrusions 9423i are engaged with corresponding second engaging protrusions 9424i and fourth engaging protrusions 9461i, the second engaging protrusions 9424i are engaged with the third engaging protrusions 9411i, to form a drive connection among the mounting element 941i, the wriggling plates 942i, and the limiting element 946i. When the mounting element 941i rotates, the wriggling plates 942i rotate around the driving rod 943i, and the massage protrusion 9422i roll in waves to massage.

It should to be understood that, the drive connection among the mounting element 941i, the wriggling plates 942i, and the limiting element 946i are formed by the protrusions, the mounting element 941i, the wriggling plates 942i, and the limiting element 946i are not fixedly connected, and the mounting element 941i, the wriggling plates 942i, and the limiting element 946i rotate around the driving rod 943i. In this way, even if some of the wriggling plates 942i cannot rotate due to being stuck, other wriggling plates 942i can still rotate normally.

In at least one embodiment, the limiting element 946i includes a pressing plate 9462i and a first bearing 9463i. The pressing plate 9462i is rotatably arranged on a top end of the driving rod 943i through the first bearing 9463i. A bottom surface of the pressing plate 9462i has the fourth engaging protrusions 9461i spaced apart from the driving rod 943i. The pressing plate 9462i resists against the adjacent wriggling plate 942i through the fourth engaging protrusions 9461i and first engaging protrusions 9423i, and the pressing plate 31 forms a drive connection on the horizontal plane with the adjacent wriggling plate 942i through the fourth engaging protrusions 9461i and first engaging protrusions 9423i.

In at least one embodiment, the limiting element 946i further has a pressing cover 9462i connected with the top end of the driving rod 943i through a screw, the pressing plate 9462i defines an eighth through hole (not labeled) at a center portion of the pressing plate 9462i. The top end of the driving rod 943i passes through the eighth through hole, so that the pressing plate 9462i is concentric with the wriggling plates 942i. The first bearing 9463i is arranged between the pressing cover 9462i and the pressing plate 9462i, so that the fourth engaging protrusions 9461i may rotate the driving rod 943i.

In at least one embodiment, the mounting element 941i includes a head 9412i, and a second shaft 9413i, the head 9412i may be rotatably connected with the lower end of the driving rod 943i through the second shaft 9413i. A top surface of the head 9412i has the third engaging protrusions 9411i spaced apart from the driving rod 943i. The head 9412i resists against the adjacent wriggling plate 942i through the third engaging protrusions 9411i, and forms the drive connection with the adjacent wriggling plate 942i on the horizontal plane through the third engaging protrusions 9411i through the third engaging protrusions 9411i and the second engaging protrusions 9424i.

In at least one embodiment, the head 9412i defines a ninth through hole 9414i formed at a center portion of the head 9412i. The lower end of the driving rod 943i passes through the ninth through hole 9414i, so that the head 9412i is concentric with the wriggling plates 942i. When the head 9412i rotates, the third engaging protrusions 9411i may rotate around the driving rod 943i.

In at least one embodiment, the driving assembly 30i further includes a speed reducer (not labeled) connected with the output shaft 31i, engaging teeth 9414i are arranged at the second shaft 9413i, the second shaft 9413i is arranged between the speed reducer and the head 9412i. An output end of the speed reducer is engaged with the engaging teeth 9414i.

It should be understood that, the end of the flexible housing 50i with the massage assembly 90i may be placed in sensitive portions to massage.

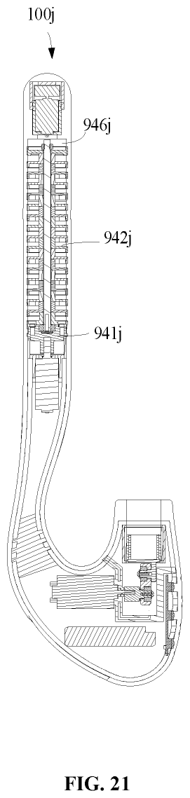

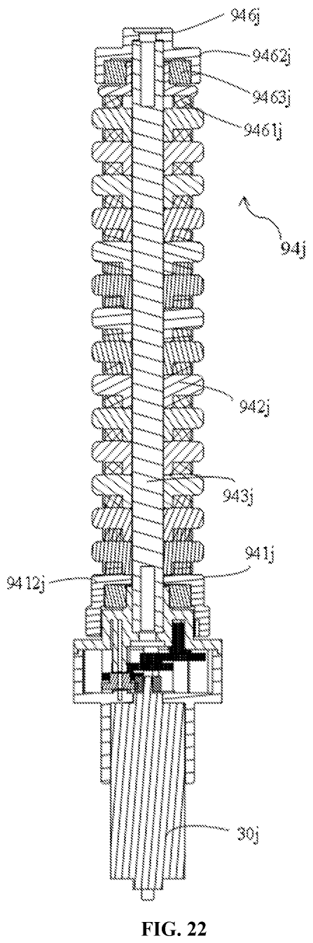

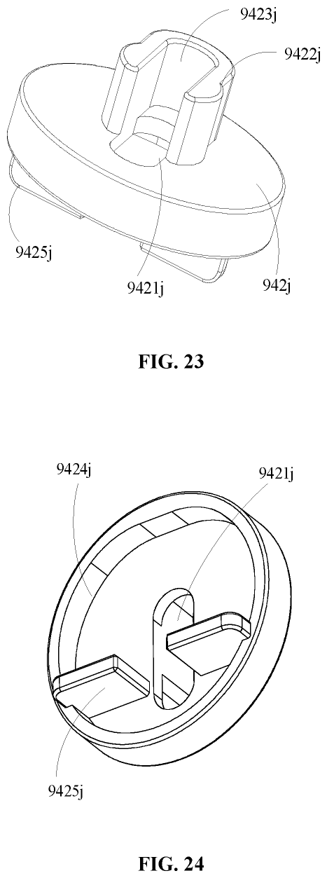

As shown in FIGS. 21 to 24, the present disclosure provides a massage device 100j according to a tenth embodiment. The massage device 100j is similar with the massage device 100i in structure. The differences between the massage device 100j and the massage device 100i include: the wriggling plate 942j is different from the wriggling plate 942i.

In at least one embodiment, the wriggling plate 942j defines a skewing groove 9421j, the skewing groove 9421j defined at a centerline of the wriggling plate 942j along a radial direction of the wriggling plate 942j. The driving rod 943j passes through the skewing grooves 9421j, so that the wriggling plates 942j are rotatably arranged around the driving rod 943j in sequence.

In at least one embodiment, the wriggling plate 942j has an eccentric block 9422j, a blocking ring 9424j, and at least two first engaging elements 9425j. The eccentric block 9422j is protruded from a top surface of the wriggling plate 942j, and arranged at a side of the skewing groove 9421j along the radial direction of the wriggling plate 942j. The eccentric block 9422j defines a notch 9423j communicated with the skewing groove 9421j. The blocking ring 9424j is arranged around a lower end of the wriggling plate 942j. The at least two first engaging element 9425j are protruded from a bottom surface of the wriggling plate 942j, and arranged symmetrically at a side of an end of the skewing groove 9421j away from the eccentric block 9422j.

In at least one embodiment, a top surface of the head 9412j is connected with the eccentric block 9422j. The pressing plate 9462j of the limiting element 946j is connected with the eccentric block 9422j of the adjacent wriggling plate 942j. The extending direction of the eccentric block 9422j is the same as that of the notch 9423j. The wriggling plate 942j may move laterally relative to the driving rod 943j. At this time, the driving rod 943i moves laterally in the skewing groove 9421j, so that there is no interference between the driving rod 943j and the eccentric block 9422j.

In at least one embodiment, the other end of the eccentric block 9422j has an arc flange (not labeled) which is away from the center of the wriggling plate 942j. The driving assembly 30j brings the head 9412j to rotate, the arc flange is matched with the blocking ring 9424j, so that the wriggling plate 942j may move laterally relative to the head 9412j.

It should be understood that, the end of the flexible housing 50j with the massage assembly 90j may be placed in sensitive portions to massage.

When the mounting element 941j rotates, the eccentric block 9422j resists against the first engaging elements 9425j, the first engaging elements 9425j is spaced apart from the center of the wriggling plate 942j, and the eccentric block 9422j may push the wriggling plates 942j to rotate around the driving rod 943j. Further, each two adjacent wriggling plates 942j may rotate in sequence and move laterally through a cooperation between the eccentric block 9422j, the skewing groove 9421j, and the first engaging element 9425j, so as to roll in waves.

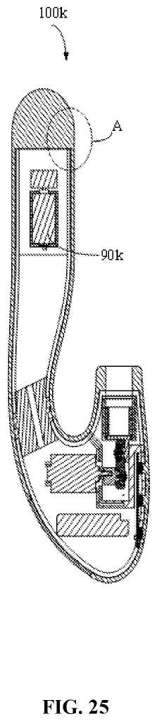

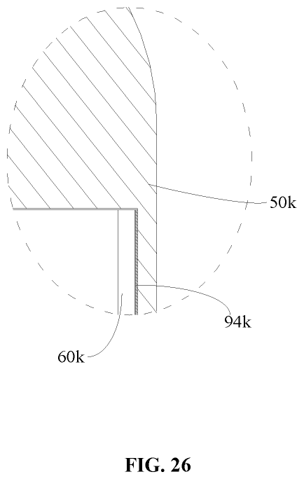

As shown in FIGS. 25 to 26, the present disclosure provides a massage device 100k according to an eleventh embodiment. The massage device 100k is similar with the massage device 100g in structure. The differences between the massage device 100k and the massage device 100g include: the massage assembly 90k further includes a temperature regulating member 94k, arranged between the flexible housing 50k and the second housing 60k, the temperature regulating member 94k includes a heating coil, or a semiconductor chilling plate.

It should be understood that, when the temperature regulating member 94k is a heating coil, the heating coil may heat the massage device 100k to provide a better massage effect; when the temperature regulating member 94k is a semiconductor chilling plate, the semiconductor chilling plate may cool or heat the massage device 100k to provide a better massage effect. The end of the flexible housing 50k with the massage assembly 90k may be placed in sensitive portions to massage.

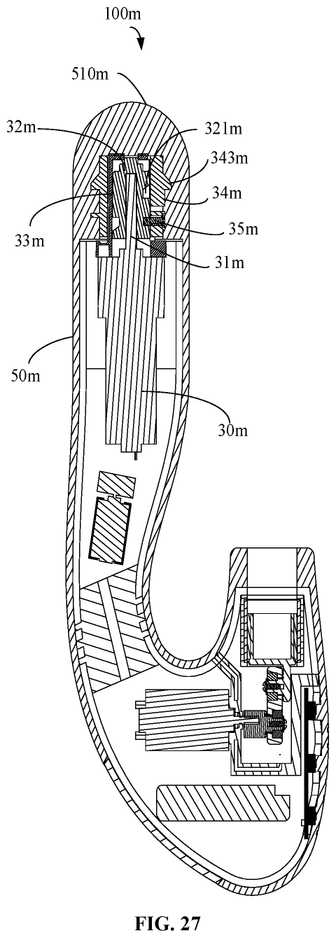

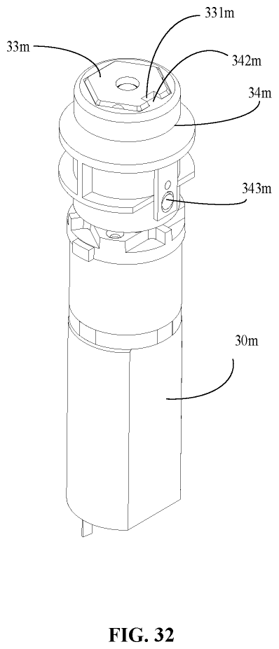

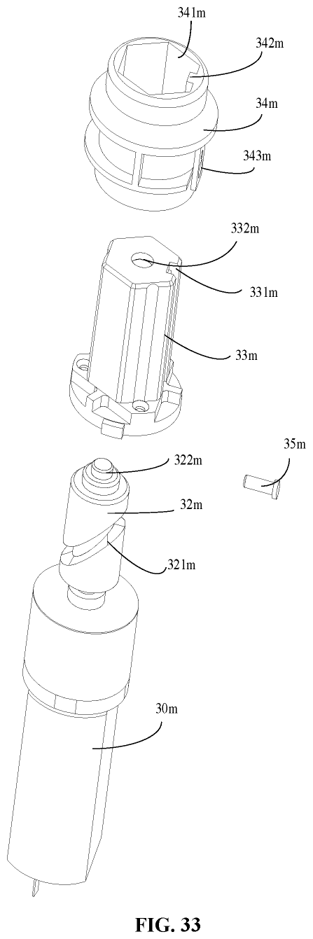

As shown in FIGS. 27 to 33, the present disclosure provides a massage device 100m according to a twelfth embodiment. The massage device 100m is similar with the massage device 100g in structure. The differences between the massage device 100m and the massage device 100g include: the driving assembly 30m includes a driving shaft 32m connected with an output shaft 31m, a fixing sleeve 33m sleeved on the driving shaft 32m and fixedly received in the flexible housing 50m, a retractable sleeve 34m sleeved on the fixing sleeve 33m and connected with a retractable portion 510m of the flexible housing 50m, and a connecting member 35m fixedly received in the retractable sleeve 34m and slidably connected with the driving shaft 32m.

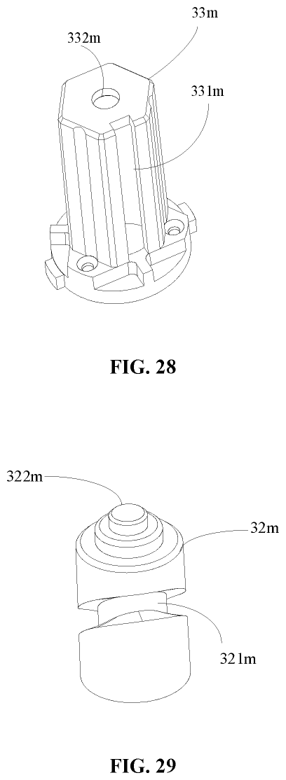

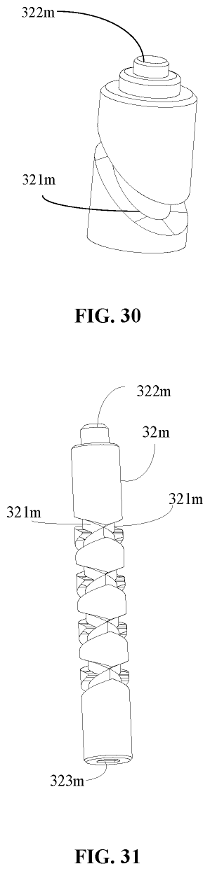

In at least one embodiment, the driving shaft 32m defines a first guiding groove 321m at an outer surface of the driving shaft 32m. The first guiding groove 321m includes two spiral grooves having different extending directions (referring to FIG. 31), or the first guiding groove 321m includes one spiral groove (referring to FIGS. 29 and 30).

In at least one embodiment, the retractable sleeve 34m defines a tenth through hole 343 through which the connecting member 35m passes, and a receiving hole 341 for receiving the fixing sleeve 33m.

In at least one embodiment, the fixing sleeve 33m has a second guiding groove 331m through which the connecting member 35m passes, and an eleventh through hole 332 through which a driving end 322 of the driving shaft 32m passes. The retractable sleeve 34m further includes a guiding block 342m slidably received in the second guiding groove 331m.

In at least one embodiment, the driving shaft 32m defines a hole 323m for receiving the output shaft 31m.

It should be understood that, the end of the flexible housing 50m with the massage assembly 90m may be placed in sensitive portions to massage.

When the driving assembly 30m works, the output shaft 31m brings the driving shaft 32m and the fixing sleeve 33m to rotate, the connecting member 35m moves along the first guiding groove 321m up and down under a limitation of the second guiding groove 331m, so as to bring the retractable portion 510m to retract to massage.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A massage device, comprising:
at least one first housing, having a first sucking port and a receiving space communicated with the first sucking port;
at least one movable assembly, movably inserted into the receiving space; and
at least one driving assembly, connected with the at least one movable assembly and being configured for driving the at least one movable assembly to reciprocate in the receiving space to periodically generate a negative pressure and a positive pressure at the first sucking port;
a massage assembly;
a second housing received in the at least one first housing, wherein the at least one movable assembly is received in a first end of the second housing, and the massage assembly is received in an opposite second end of the second housing.

2. The massage device according to claim 1, wherein the at least one driving assembly comprises a first driving assembly and a second driving assembly;
the at least one movable assembly comprises:
a free end, movably inserted into the receiving space;
a moving end, connected with the free end; and
a connecting rod, connected with an end of the moving end away from the free end;
the first driving assembly comprises:
an output shaft; and
an eccentric shaft, connected with the connecting rods and the output shaft.

3. The massage device according to claim 2, wherein the second driving assembly comprises:
an output shaft; and
a driving member, having an elliptical groove and connected with the output shaft, ends of the two claws are received in the elliptical groove and limited by a side wall of the elliptical groove.

4. The massage device according to claim 3, wherein the massage assembly comprises:
two claws; and
a pin, connected with the two claws and configured to allow the two claws to move towards each other or move away from each other.

5. The massage device according to claim 3, wherein the driving member has an elliptical shape, a surface of the driving member has the elliptical groove, and a protrusion is received in the elliptical groove.

6. The massage device according to claim 5, wherein the protrusion has an elliptical shape.

7. The massage device according to claim 2, wherein the at least one movable assembly comprises a first movable assembly and a second movable assembly; the massage device further comprises a flexible member received in the second housing, and the flexible member is arranged between the first movable assembly and the second movable assembly.

8. The massage device according to claim 7, wherein the flexible member is made of a material capable of being bent and shaped.

9. The massage device according to claim 8, wherein the flexible member is made of a memory alloy.

10. The massage device according to claim 2, wherein the first driving assembly and the second driving assembly are received in two opposite ends of the second housing.

11. The massage device according to claim 1, wherein the second housing is rigid.

12. The massage device according to claim 11, wherein the second housing is made of thermosetting plastic.
